(19) United States
(12) Patent Application Publication
(10) Pub. No.: US 2015/0117322 A1
(43) Pub. Date: Apr. 30, 2015

(54) Policy-Based Control Mechanism For Wireless Network Physical Layer Resources

(71) Applicant: Aruba Networks, Inc., Sunnyvale, CA (US)

(72) Inventors: Scott McGrath, Boscawen, NH (US); Neal Castagnoli, Morgan Hill, CA (US)

(73) Assignee: Aruba Networks, Inc., Sunnyvale, CA (US)

(21) Appl. No.: 14/067,826

(22) Filed: Oct. 30, 2013

(51) Int. Cl. H04W 72/04

(52) U.S. Cl. CPC H04W 72/0493
USPC 370/329

(57) ABSTRACT

Embodiments of the present disclosure relate to physical layer resource utilization in wireless local area networks. In particular, the present disclosure relates to a policy-based control mechanism for wireless network physical layer resources such as transmit beamforming. Specifically, the disclosed system receives a set of network policy criteria, and information associated with each of a plurality of client devices connected to a network device. The disclosed system then selects a subset of client devices in a wireless network based on the set of network policy criteria and information associated with each of the plurality of client devices. Furthermore, the disclosed system provides the subset of client devices for using one or more of wireless network physical layer resources. Here, the wireless network physical layer resources are limited to a threshold number of client devices. Moreover, the number of client devices in the subset does not exceed the threshold number.

### FIELD

The present disclosure relates to physical layer resource utilization in wireless local area networks. In particular, the present disclosure relates to a policy-based control mechanism for wireless network physical layer resources such as transmit beamforming.

### BACKGROUND

Wireless networks in compliance with IEEE 802.11 ac standards involve a number of physical layer enhancements, such as transmit beamforming (TxBF), multi-user MIMO, multiple spatial streams, enhanced channel width, space time block coding (STBC), etc. Specifically, transmit beamforming (TxBF) allows an access point in a wireless local area network (WLAN) to focus its transmission to a particular client in the direction of that client, and vice versa for a client with multiple antennas. Thus, beamforming allows for higher signal to noise ratios, and hence higher data rates than those in cases without beamforming technology.

Nevertheless, such WLAN physical layer enhancements are usually limited. For example, a radio chip set of a wireless access point may be able to support a total of 100 clients per radio. However, the same radio chip set can support only 7 beamforming entries. Thus, only a small fraction of all clients can benefit from the use of beamforming technology due to the above-mentioned hardware limitations.

Conventionally, determination of which wireless client is allowed to use beamforming is based on a First In, First Out (FIFO) basis. From a system operator's perspective, this is not an optimal solution, because allocating the limited number of transmit beamforming entries on each radio on a first-come first-serve basis does not necessarily provide improvements on system performance will be improved.

The beamforming clients may or may not be the best candidates for receiving such physical layer enhancements. Specifically, while all clients benefit from transmit beamforming, due to a variety of factors, the clients that gain most benefits from transmit beamforming tend to be either single or dual chain client devices with small antennas. Transmit beamforming (TxBF) improves the apparent signal quality for such client devices, and accordingly, improves the user experience.

### BRIEF DESCRIPTION OF THE DRAWINGS

The present disclosure may be best understood by referring to the following description and accompanying drawings that are used to illustrate embodiments of the present disclosure.

FIG. 1 illustrates a beamforming example according to embodiments of the present disclosure.

FIG. 2 illustrates exemplary beamforming entries according to embodiments of the present disclosure.

FIG. 3 is a diagram illustrating exemplary beamforming policies according to embodiments of the present disclosure.

FIG. 4 is a flowchart illustrating an exemplary process for policy-based control mechanism for wireless network physical layer resources according to embodiments of the present disclosure.

FIG. 5 is a block diagram illustrating an exemplary system for policy-based control mechanism for wireless network physical layer resources according to embodiments of the present disclosure.

### DETAILED DESCRIPTION

In the following description, several specific details are presented to provide a thorough understanding. While the context of the disclosure is directed to network flooding, one skilled in the relevant art will recognize, however, that the concepts and techniques disclosed herein can be practiced without one or more of the specific details, or in combination with other components, etc. In other instances, well-known implementations or operations are not shown or described in details to avoid obscuring aspects of various examples disclosed herein. It should be understood that this disclosure covers all modifications, equivalents, and alternatives falling within the spirit and scope of the present disclosure.

### Overview

Embodiments of the present disclosure relate to physical layer resource utilization in wireless local area networks. In particular, the present disclosure relates to a policy-based control mechanism for wireless network physical layer resources such as transmit beamforming. Specifically, Embodiments of the present disclosure relate to physical layer resource utilization in wireless local area networks. In particular, the present disclosure relates to a policy-based control mechanism for wireless network physical layer resources such as transmit beamforming. Specifically, the disclosed system receives a set of network policy criteria, and information associated with each of a plurality of client devices connected to a network device. The disclosed system then selects a subset of client devices in a wireless network based on the set of network policy criteria and information associated with each of the plurality of client devices. Furthermore, the disclosed system provides the subset of client devices for using one or more of wireless network physical layer resources. Here, the wireless network physical layer resources are limited to a threshold number of client devices. Moreover, the number of client devices in the subset does not exceed the threshold number.

### Beamforming

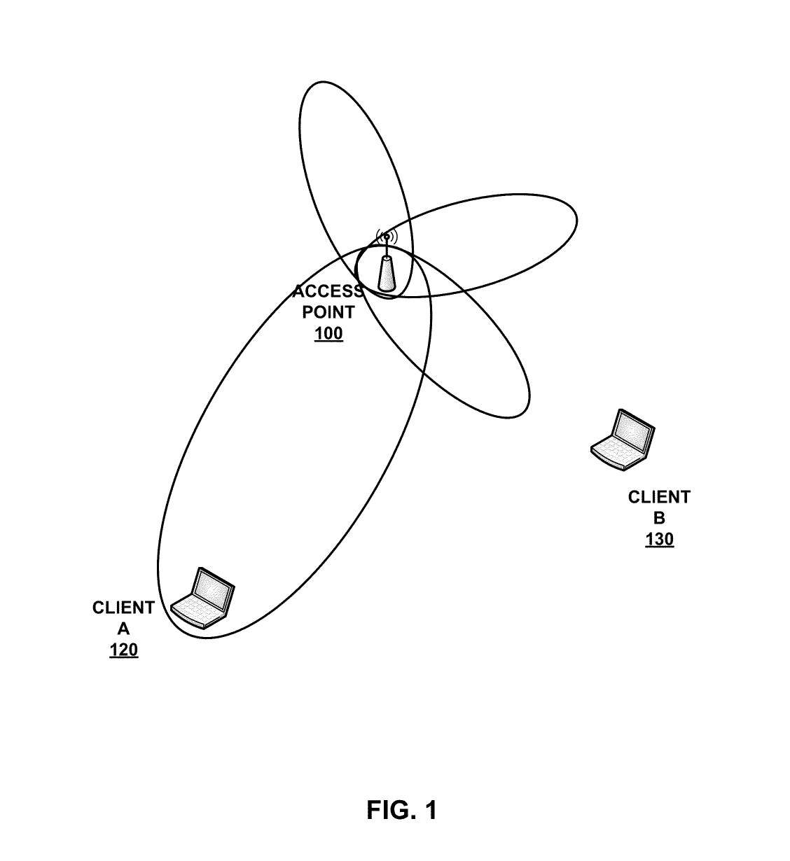

FIG. 1 illustrates a beamforming example according to embodiments of the present disclosure. FIG. 1A includes at least an access point 100, a desired client device Client A 120, and an interfering client device Client B 130.

An access point may be interconnected with zero or more client devices via either a wired interface or a wireless interface. An access point generally refers to a network device that allows wireless clients to connect to a wired network. Access points usually connect to other network devices via a wired or wireless network.

A client device may be a computing device that includes a memory and a processor, for example a laptop computer, a desktop computer, a tablet computer, a mobile telephone, a personal digital assistant (PDA), a mobile email device, a portable game player, a portable music player, a reader device, a television with one or more processors embedded therein or coupled thereto or other electronic device capable of accessing a network.

In FIG. 1, each area encircled by an ellipse represents a corresponding signal coverage area whose size correlates to the signal strength in the respective direction. As illustrated in FIG. 1, access point 100 can focus its signals toward a desired client, such as Client A 120, and away from an interfering client, such as client B 130.

In order to focus the signals toward Client A 120, sounding frames are used with beamforming. Specifically, a transmitter, for example, at access point 120, sends a known pattern of radio frequency (RF) symbols from each antenna, allowing the receiver, for example, Client A 120, to construct a matrix for how each receive antenna hears each transmit antenna. The matrix information is sent back to the transmitter at access point 100, allowing it to invert the matrix and use the optimum amplitude-phase settings to achieve best reception. With a single-antenna receiver, this result in a local maximum signal-to-noise ratio (SNR) for effective beamforming.

Furthermore, in some embodiments, multiple antennas can be used to beam a signal onto the receiver's antenna, e.g., in compliance with IEEE 802.11 ac standards. For example, a full sounding sequence may comprise a set of special sounding frames sent by the transmitter (e.g., the beamformer, or access point 100), and a set of compressed V matrix frames returned by the beamformee (e.g., client A 120).

Because multiple clients are involved in multi-user MIMO, a specific protocol is used to ensure that the multiple clients answer with feedback frames in sequence following the sounding frame. First, the beamformer sends a null data packet announcement (NDPA) frame identifying the intended recipients and the format of the forthcoming sounding frame. This is followed by the sounding null data packet (NDP) itself, and the beamformee then responds with a beamforming report frame. The NDPA frame identifies which client devices should listen to the subsequent sounding frame, as well as the dimensions of that frame depending on the number of antennas and spatial streams in use. The sounding frame is typically a NDP.

The beamformees measures the RF channel characteristics, then processes and returns the measurements as a compressed steering matrix to the beamformer. Specifically, the matrix of the received signal is constructed with magnitude and phase for each antenna combination (transmit and receive). Then, successive matrix multiplication operations are performed to make the matrix an invertible matrix. Finally, the parameters (e.g., angles) used in the matrix operations are assembled with power and phase figures, and the compressed matrix is returned to the beamformer.

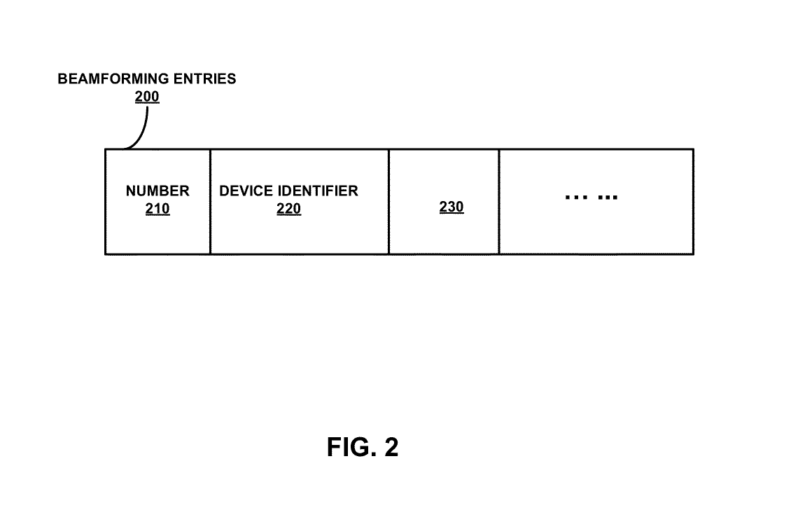

FIG. 2 illustrates exemplary beamforming entries according to embodiments of the present disclosure. In particular, FIG. 2 illustrates an exemplary beamforming entry 200, which is identified by number 210 and includes information such as device identification 220, etc.

Therefore, each beamforming entry 200 maps to a specific radio of a specific client device. Once a client device identifier is included in the beamforming entry, all subsequent transmission to and from the client will utilize beamforming to focus the signal to the specific radio of the specific client device, even when the client device is mobile and roams within the wireless network.

The beamforming interval at which the beamforming angles for the specific client devices are computed can be set by a network administrator. For example, the system may set a default beamforming interval value of 25 ms.

### Policy-Based Control Mechanism for Physical Layer Resources

According to embodiments of the present disclosure, a control mechanism can leverage various network policies to allocate limited wireless network physical layer resources to a subset of clients that can benefit most from such resources. Specifically, the disclosed system allows a network administrator to define a network policy. The network policy controls the Physical Layer (hereafter referred to as the “PHY”) of the wireless system.

In general, a network according to embodiments of the present disclosure serves a set of client devices. The total number of the client devices exceeds the limited number of transmit beamforming entries that the system can support. The disclosed system will first select one or more of network policies based on preference set by the network administrator.

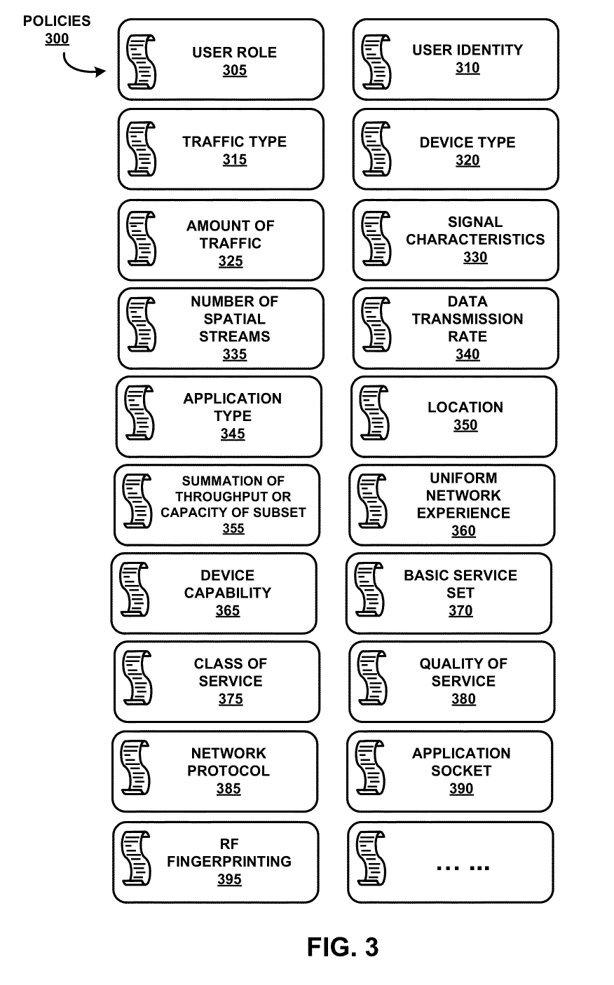

Here, a network policy generally refers to choices made by the administrator as to which clients the system shall apply performance optimization. As illustrated in FIG. 3, policies 300 may include, but is not limited to, user roles 305 and/or user identity 310, traffic type 315 as detected by deep packet inspection (DPI), device type 320, amount of traffic 325, signal characteristics 330, number of spatial streams 335, data transmission rate 340, application type 345, location 350, summation of throughput/capacity of selected devices 355, uniform network experience 360, device capability 365, per basic service set 370, class of service 375, quality of service 380, network protocol 385, application socket 390, radio frequency (RF) fingerprinting characteristics 395, etc.

For example, a conventional wireless phone often has a SISO (Single-In, Single-Out) antenna system. By contrast, a laptop computer usually has multiple antennas. By using beamforming technology, the network system can increase the coverage range for the handheld device, or increase the data transmission rate, or both. Thus, for a TxBF PHY, a network policy may be defined such that only wireless handheld devices will be granted an available TxBF PHY entry because the wireless handheld devices are more likely than other devices to benefit from transmit beamforming. Alternatively, a network policy may be defined such that TxBF PHY entry is not available to a client device with multiple spatial streams, such as a laptop client device, in the network.

As another example, a network policy may be defined based on user roles. Specifically, if a client device belongs to a VIP user, the network system will allocate a TxBF PHY entry to the client device to optimize the VIP user's experience. Similarly, a subset users of the network may be identified as the first responders in emergency situations, the network policy may be defined so that transmit beamforming will be available to client devices associated with these identified first responders. Note that, information regarding to the user/device roles or identities may be externally stored in a database or implicitly derived.

For example, among wireless mobile phones, a hotspot network operator may want to define a policy that allows the use of beamforming for a client device if the received signal strength value from the client device is below a predefined threshold. The received signal strength value can be measured as, e.g., received signal strength indicator (RSSI), signal to noise ratio (SNR), etc. Such a policy is desirable for the hotspot network operator because the hotspot provider often can collect revenue only for the time duration when a mobile client device is connected to the network. Note that, because the number of beamforming entries is less than the total number of concurrent clients that the network is capable of supporting, it is beneficial to provide a mechanism to allow the network operator to leverage various policies to prioritize clients as much as possible.

As another example, a network administrator at a public venue may desire to provide high quality video signals to handsets or tablet devices. Thus, a network policy may be defined based on traffic type (e.g., streaming video, audio, VoIP, etc.) or type of application running on the client device to prioritize clients that are running a video application. In some embodiments, traffic type may be determined based on deep packet inspection. In some embodiments, a combination of factors, e.g., device type combined with traffic type, may be used to prioritize different clients. In one embodiment, beamforming is enabled for the clients that best match a set of criteria based on the combination of the factors.

As another example, a network policy may be defined based on device connectivity, which can be determined by factors, such as, signal strength, signal characteristics, number of spatial streams, etc. For example, if an access point receives a weak signal from a client device, the access point may use beamforming to boost the signal strength to the client device. In addition, a network policy may be defined to allow maximization of the overall throughput for the subset of client devices selected for beamforming.

In yet another example, a network administrator may desire to provide network users a uniform experience. Hence, he/she may define a network policy that allows for beamforming on client devices suffering from poor network performance. The disclosed system can then test different sets of beamforming client selections, and choose the client selection that provides the most uniform client experience.

In one embodiment, the network policy may define that client devices located within a specific area are allowed for beamforming. For example, a network administrator may want to configure an executive conference room as a high priority location. Thus, information regarding devices that are roamed to the executive conference room will be added to the TxBF PHY entries. As another example, if due to floor layout, a certain area of the building tends to have poor signal coverage, that area with poor signal coverage may be set as a high priority location, so that whenever a network user enters the area, beamforming will be enabled for his/her devices to provide a performance boost.

In one embodiment, a network policy may enable beamforming and/or other PHY enhancements for devices associated with one or more specific basic service set (BSS). In another embodiment, a network policy may specify a network socket and/or a network protocol, and enable beamforming for client devices running an application through the specified network socket or using the specified network protocol.

In one embodiment, a network policy may enable beamforming and/or other PHY enhancements for a subset of devices with heavy traffic loads. In another embodiment, a network policy may enable beamforming and/or other PHY enhancements for a subset of clients communicating on a particular wireless band frequency range.

In one embodiment, a network policy may enable beamforming and/or other PHY enhancement based on a set of envelope characteristics, which identify characteristics of certain radios, and/or RF fingerprinting. In another embodiment, a network policy may enable beamforming and/or other PHY enhancement based on class of services, for example, whether a client device has subscribed to a particular service.

Moreover, wireless network PHY enhancements may be enabled based on a hierarchy of network policies so that multiple levels of selection criteria can be applied. For example, the first layer of selection criteria could be based on traffic type as determined by deep packet inspection, e.g., streaming video; the second level of selection criteria could be based on client type, e.g., handset or tablet devices as determined by Dynamic Host Configuration Protocol (DHCP), Hypertext Transfer Protocol (HTTP), Deep Packet Inspection (DPI) fingerprinting, etc.; and, the third level of selection criteria could be based on client capability, e.g., whether this particular endpoint device supports the PHY enhancement. In some embodiments, only the subset of clients matching the entire hierarchy of selectors is granted access to the limited PHY enhancements.

In some embodiments, PHY enhancement policies are created by the administrator in a top-down manner, for example, starting at the application layer with each underneath layer of the Open Systems Interconnection (OSI) model optionally allowing a policy to be set or not set depending on the network administrator's needs. This policy is then applied to the traffic flowing through an access point, for example, on either a per-radio basis or a per-basic service set identifier (BSSID) basis. Note that, per-BSSID basis is needed for a multi-tenant model.

Clients matching the largest number of policies in a priority order are then assigned to be enabled for PHY enhancements in such priority order. A queue identifying clients that are enabled for PHY enhancements is maintained by the disclosed system, such that when a client ceases using the radio, the client with the next highest priority is assigned to be enabled for the PHY enhancement. Also, a timeout value for PHY enhancement can be controlled by the network administrator. The timeout value may potentially range from milliseconds to hours depending on the access point installation type. For example, an access point providing wireless service for moving vehicles may only have any given vehicle in sight and using radio for a few seconds, and thus a relatively short timeout value may be set for this access point. As another example, access points in a warehouse or near a production line may serve a given set of robots that work in a limited area for hours at a time. Hence, a relatively long timeout value may be set for these access points in the warehouse or near the production line.

### Processes for Policy-Based Control Mechanism for Wireless Network Physical Layer Resources

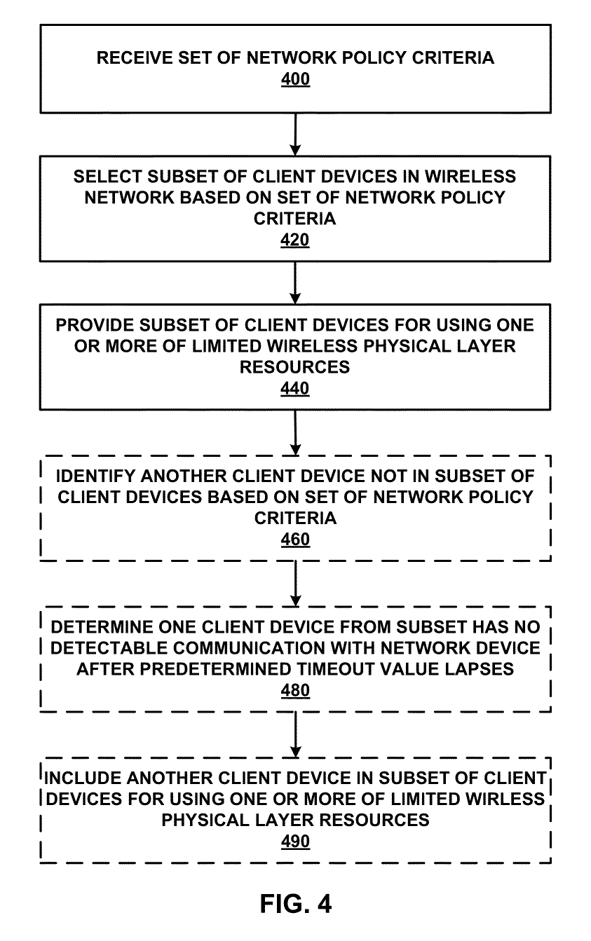

FIG. 4 is a flowchart illustrating exemplary processes for policy-based control mechanism for wireless network physical layer resources. As illustrated in FIG. 4, during operations, the disclosed system receives a set of network policy criteria (operation 400). Also, the system receives information associated with each of a plurality of client devices in a wireless network. Then, the disclosed system selects a subset of the plurality of network devices in the wireless network at least based on the set of network policy criteria and the information associated with each of the plurality of client devices (operation 420). Furthermore, the disclosed system provides the subset of client devices for using one or more of limited wireless physical layer resources (operation 440). Note that, the total number of the plurality of client devices exceeds the limited number of wireless physical layer resources.

Moreover, the disclosed system can optionally identify another client device that is not in the subset of client devices based on the set of network policy criteria (operation 460). The disclosed system also determines that one client device from subset has no detectable communication with the network device after a predetermined timeout value lapses (operation 480). In response, the disclosed system includes the other identified client device in the subset of client devices, and provides the other identified client device for using one or more of the limited wireless physical layer resources (operation 480).

### System for Policy-Based Control Mechanism for Wireless Network Physical Layer Resources

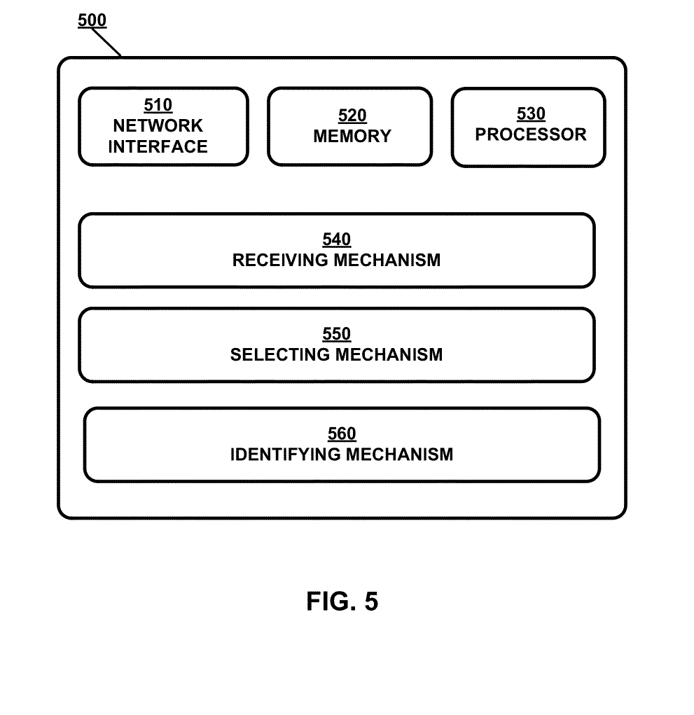

FIG. 5 is a block diagram illustrating a network device system for policy-based control mechanism for wireless network physical layer resources. Network device 500 includes at least a network interface 510 capable of communicating to a wired network, a memory 520 capable of storing data, a processor 530 capable of processing network data packets, and a number of mechanisms coupled to the processor 530. The mechanisms include, but are not limited to, a receiving mechanism 540, a selecting mechanism 550, a identifying mechanism 560, etc. Note that, network device 500 may be used as a network switch, network router, network controller, network server, etc. Furthermore, network device 500 may serve as a node in a distributed or a cloud computing environment.

Network interface 510 can be any communication interface, which includes but is not limited to, a modem, token ring interface, Ethernet interface, wireless IEEE 802.11 interface (e.g., IEEE 802.11n, IEEE 802.11ac, IEEE 802.11ad, etc.), cellular wireless interface, satellite transmission interface, or any other interface for coupling network devices. In some embodiments, network interface 510 may be software-defined and programmable, for example, via an Application Programming Interface (API), and thus allowing for remote control of the network device 500.

Memory 520 can include storage components, such as, Dynamic Random Access Memory (DRAM), Static Random Access Memory (SRAM), etc. In some embodiments, memory 520 includes transmit beamforming entries or other entries/tables corresponding to limited wireless network physical layer resources.

Processor 530 typically includes a networking processor that is capable of processing network data traffic. In some embodiments, processor 530 may include multiple processing cores and/or ASICs.

Receiving mechanism 540 generally receives packets from a wireless network. Moreover, receiving mechanism 540 receives network policy criteria, as well as information associated with each of a plurality of client devices connected to network device 500.

Selecting mechanism 550 generally selects a subset of the plurality of client devices for using a first number of wireless network physical layer resources based on the network policy criteria and the information associated with each of the plurality of client devices. Note that, a second number of the plurality of client devices exceeds the first number of the wireless network physical layer resources. In one embodiment, the selecting mechanism selects the subset comprises selecting the subset of the plurality of client devices for communication with the network device using a transmit beamforming functionality of the network device. the selecting mechanism selecting the subset comprises selecting the subset of the plurality of client devices for communication with the network device using one or more of the following functionalities of the network device: multi-user multiple-input and multiple-output; multiple spatial streams; enhanced channel width; and space time block coding.

Furthermore, the information associated with each of the plurality of client devices comprise one or more of: a user role associated with a respective client device; a user identity associated with the respective client device; a traffic type associated with traffic transmitted by the respective client device; a device type associated with the respective client device; an amount of traffic transmitted by the respective client device; a signal characteristic associated with a signal transmitted by the respective client device; a number of spatial streams associated with the respective client device; a data transmission rate associated with the traffic transmitted by the respective client device; an application type associated with an application executing on the respective client device; a location associated with the respective client device; a class of service (CoS) associated with the traffic transmitted by the respective client device; a quality of service (QoS) associated with the traffic transmitted by the respective client device; a network protocol associated with the traffic transmitted by the respective client device; an application socket associated with the application executing on the respective client device; a radio frequency (RF) fingerprinting characteristic associated with the signal transmitted by the respective client device; etc.

In some embodiments, the selected subset of client devices matches to most number of the set of network policy criteria.

In some embodiments, selecting mechanism 550 selects the subset of client devices that correspond to high priority users in the wireless network.

In some embodiments, selecting mechanism 550 includes a client device to the subset of client devices in response to the received signal strength value of a signal from the client device being below a predetermined threshold.

In some embodiments, selecting mechanism 550 selects the subset of the plurality of client devices to maximize overall throughput for the selected subset of client devices.

In some embodiments, selecting mechanism 550 selects client devices located within a predefined area as the subset of client devices.

Identifying mechanism 560 generally identifies another client device not in the subset of client devices based on the set of network policy criteria. In response to one client device from the subset of client devices has no detectable communication with the network device after a predefined timeout value lapses, selecting mechanism includes the other client device in the subset of client devices.

According to embodiments of the present disclosure, network services provided by network device 500, solely or in combination with other wireless network devices, include, but are not limited to, an Institute of Electrical and Electronics Engineers (IEEE) 802.1x authentication to an internal and/or external Remote Authentication Dial-In User Service (RADIUS) server; an MAC authentication to an internal and/or external RADIUS server; a built-in Dynamic Host Configuration Protocol (DHCP) service to assign wireless client devices IP addresses; an internal secured management interface; Layer-3 forwarding; Network Address Translation (NAT) service between the wireless network and a wired network coupled to the network device; an internal and/or external captive portal; an external management system for managing the network devices in the wireless network; etc.

The present disclosure may be realized in hardware, software, or a combination of hardware and software. The present disclosure may be realized in a centralized fashion in one computer system or in a distributed fashion where different elements are spread across several interconnected computer systems coupled to a network. A typical combination of hardware and software may be an access point with a computer program that, when being loaded and executed, controls the device such that it carries out the methods described herein.

The present disclosure also may be embedded in non-transitory fashion in a computer-readable storage medium (e.g., a programmable circuit; a semiconductor memory such as a volatile memory such as random access memory “RAM,” or non-volatile memory such as read-only memory, power-backed RAM, flash memory, phase-change memory or the like; a hard disk drive; an optical disc drive; or any connector for receiving a portable memory device such as a Universal Serial Bus “USB” flash drive), which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

As used herein, “digital device” generally includes a device that is adapted to transmit and/or receive signaling and to process information within such signaling such as a station (e.g., any data processing equipment such as a computer, cellular phone, personal digital assistant, tablet devices, etc.), an access point, data transfer devices (such as network switches, routers, controllers, etc.) or the like.

As used herein, “access point” (AP) generally refers to receiving points for any known or convenient wireless access technology which may later become known. Specifically, the term AP is not intended to be limited to IEEE 802.11-based APs. APs generally function as an electronic device that is adapted to allow wireless devices to connect to a wired network via various communications standards.

As used herein, the term “interconnect” or used descriptively as “interconnected” is generally defined as a communication pathway established over an information-carrying medium. The “interconnect” may be a wired interconnect, wherein the medium is a physical medium (e.g., electrical wire, optical fiber, cable, bus traces, etc.), a wireless interconnect (e.g., air in combination with wireless signaling technology) or a combination of these technologies.

As used herein, “information” is generally defined as data, address, control, management (e.g., statistics) or any combination thereof. For transmission, information may be transmitted as a message, namely a collection of bits in a predetermined format. One type of message, namely a wireless message, includes a header and payload data having a predetermined number of bits of information. The wireless message may be placed in a format as one or more packets, frames or cells.

As used herein, “wireless local area network” (WLAN) generally refers to a communications network links two or more devices using some wireless distribution method (for example, spread-spectrum or orthogonal frequency-division multiplexing radio), and usually providing a connection through an access point to the Internet; and thus, providing users with the mobility to move around within a local coverage area and still stay connected to the network.

As used herein, the term “mechanism” generally refers to a component of a system or device to serve one or more functions, including but not limited to, software components, electronic components, electrical components, mechanical components, electro-mechanical components, etc.

As used herein, the term “embodiment” generally refers an embodiment that serves to illustrate by way of example but not limitation.

It will be appreciated to those skilled in the art that the preceding examples and embodiments are exemplary and not limiting to the scope of the present disclosure. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of the present disclosure.

While the present disclosure has been described in terms of various embodiments, the present disclosure should not be limited to only those embodiments described, but can be practiced with modification and alteration within the spirit and scope of the appended claims. Likewise, where a reference to a standard is made in the present disclosure, the reference is generally made to the current version of the standard as applicable to the disclosed technology area. However, the described embodiments may be practiced under subsequent development of the standard within the spirit and scope of the description and appended claims. The description is thus to be regarded as illustrative rather than limiting.

What is claimed is:

1. A non-transitory computer-readable storage medium storing embedded instructions for a plurality of operations that are executed by one or more mechanisms implemented within a network device having a processor and a memory, the plurality of operations comprising:
receiving network policy criteria;
receiving information associated with each of a plurality of client devices connected to the network device; and
based on the network policy criteria and the information associated with each of the plurality of client devices, selecting a subset of the plurality of client devices for using a first number of wireless network physical layer resources,
wherein a second number of the plurality of client devices exceeds the first number of the wireless network physical layer resources.

2. The non-transitory computer-readable storage medium of claim 1, wherein selecting the subset comprises selecting the subset of the plurality of client devices for communication with the network device using a transmit beamforming functionality of the network device.

3. The non-transitory computer-readable storage medium of claim 1, wherein selecting the subset comprises selecting the subset of the plurality of client devices for communication with the network device using one or more of the following functionalities of the network device:
multi-user multiple-input and multiple-output;
multiple spatial streams;
enhanced channel width; and
space time block coding.

4. The non-transitory computer-readable storage medium of claim 1, wherein the information associated with the client devices comprises one or more of:
a user role associated with a respective client device;
a user identity associated with the respective client device;
a traffic type associated with traffic transmitted by the respective client device;
a device type associated with the respective client device;
an amount of traffic transmitted by the respective client device;
a signal characteristic associated with a signal transmitted by the respective client device;
a number of spatial streams associated with the respective client device;
a data transmission rate associated with the traffic transmitted by the respective client device;
an application type associated with an application executing on the respective client device;
a location associated with the respective client device;
a class of service (CoS) associated with the traffic transmitted by the respective client device;
a quality of service (QoS) associated with the traffic transmitted by the respective client device;
a network protocol associated with the traffic transmitted by the respective client device;
an application socket associated with the application executing on the respective client device; and
a radio frequency (RF) fingerprinting characteristic associated with the signal transmitted by the respective client device.

5. The non-transitory computer-readable storage medium of claim 3, wherein the subset of client devices matches to most number of the set of network policy criteria.

6. The non-transitory computer-readable storage medium of claim 1, wherein the set of network policy criteria comprises selecting the subset of client devices that correspond to high priority users in the wireless network.

7. The non-transitory computer-readable storage medium of claim 1, wherein the set of network policy criteria comprises including a client device to the subset of client devices in response to the received signal strength value of a signal from the client device being below a predetermined threshold.

8. The non-transitory computer-readable storage medium of claim 1, wherein the set of network policy criteria comprises maximizing overall throughput for the subset of client devices.

9. The non-transitory computer-readable storage medium of claim 1, wherein the set of network policy criteria comprises selecting client devices located within a predefined area as the subset of client devices.

10. The non-transitory computer-readable storage medium of claim 1, further comprising:
identifying another client device not in the subset of client devices based on the set of network policy criteria; and
including the other client device in the subset of client devices in response to one client device from the subset of client devices has no detectable communication with the network device after a predefined timeout value lapses.

11. A network device comprising:
a processor;
a memory;
a network interface to receive one or more data packets,
a receiving mechanism coupled to the processor, the receiving mechanism receiving network policy criteria, wherein the receiving mechanism further receiving information associated with each of a plurality of client devices connected to the network device; and
a selecting mechanism coupled to the processor, the selecting mechanism selecting a subset of the plurality of client devices in a wireless network for using a first number of wireless network physical layer resources based on the network policy criteria and the information associated with each of the plurality of client devices,
wherein a second number of the plurality of client devices exceeds the first number of the wireless network physical layer resources.

12. The network device of claim 11, wherein the selecting mechanism selecting the subset comprises selecting the subset of the plurality of client devices for communication with the network device using a transmit beamforming functionality of the network device.

13. The network device of claim 11, wherein the selecting mechanism selecting the subset comprises selecting the subset of the plurality of client devices for communication with the network device using one or more of the following functionalities of the network device:
multi-user multiple-input and multiple-output;
multiple spatial streams;
enhanced channel width; and
space time block coding.

14. The network device of claim 11, wherein the information associated with each of the plurality of client devices comprise one or more of:
a user role associated with a respective client device;
a user identity associated with the respective client device;
a traffic type associated with traffic transmitted by the respective client device;
a device type associated with the respective client device;
an amount of traffic transmitted by the respective client device;
a signal characteristic associated with a signal transmitted by the respective client device;
a number of spatial streams associated with the respective client device;
a data transmission rate associated with the traffic transmitted by the respective client device;
an application type associated with an application executing on the respective client device;
a location associated with the respective client device;
a class of service (CoS) associated with the traffic transmitted by the respective client device;
a quality of service (QoS) associated with the traffic transmitted by the respective client device;
a network protocol associated with the traffic transmitted by the respective client device;
an application socket associated with the application executing on the respective client device; and
a radio frequency (RF) fingerprinting characteristic associated with the signal transmitted by the respective client device.

15. The network device of claim 13, wherein the subset of client devices matches to most number of the set of network policy criteria.

16. The network device of claim 11, wherein the set of network policy criteria comprises selecting the subset of client devices that correspond to high priority users in the wireless network.

17. The network device of claim 11, wherein the set of network policy criteria comprises including a client device to the subset of client devices in response to the received signal strength value of a signal from the client device being below a predetermined threshold.

18. The network device of claim 11, wherein the set of network policy criteria comprises maximizing overall throughput for the subset of client devices.

19. The network device of claim 11, wherein the set of network policy criteria comprises selecting client devices located within a predefined area as the subset of client devices.

20. The network device of claim 11, further comprising:
an identifying mechanism coupled to the processor, the identifying mechanism identifying another client device not in the subset of client devices based on the set of network policy criteria; and
wherein the selecting mechanism includes the other client device in the subset of client devices in response to one client device from the subset of client devices has no detectable communication with the network device after a predefined timeout value lapses.
